(19) United States
(12) Patent Application Publication
(10) Pub. No.: US 2026/0103227 A1
(43) Pub. Date: Apr. 16, 2026

(54) Platform Cart Assembly

(71) Applicant: Royal Basket Trucks, Inc., Darien, WI (US)

(72) Inventor: Ezekiel Gordon Matzke, Delavan, WI (US)

(21) Appl. No.: 19/294,558

(22) Filed: Aug. 8, 2025

Related U.S. Application Data
(60) Provisional application No. 63/706,129, filed on Oct. 11, 2024.

(51) Int. Cl. B62B 5/06; B62B 3/00; B62B 5/04

(52) U.S. Cl. CPC B62B 5/06; B62B 5/04; B62B 3/008; B62B 2301/05; B62B 2501/065

(57) ABSTRACT

A rollable platform cart assembly defined by respective deck and handle assemblies. A base frame of the deck assembly and the handle assembly are formed wholly of interconnected polyvinyl chloride (PVC) fittings and tubes. A platform is connected to the base frame and accommodates securing of the handle assembly and respective braces that extend forward of the handle assembly to the deck assembly to limit deflection of the handle assembly. A plurality of casters are attached to the base frame and accommodate rollable use of the platform cart assembly. Connection of the plurality of casters and permanent connection of the handle assembly and braces to the base assembly is left to the user such that the rolling platform cart assembly can be stored and shipped in a compact form factor prior to deployment of the respective platform cart assemblies.

### CROSS REFERENCE TO RELATED APPLICATIONS

This application claims priority to U.S. Provisional Patent Application Ser. No. 63/706,129 filed on Oct. 11, 2024 titled “Platform Cart Assembly” and the disclosure of which is incorporated herein.

### FIELD OF THE INVENTION

The present invention relates generally to transport cart assemblies, and more particularly, to a platform cart assembly that is constructed nearly entirely of polyvinyl chloride (PVC) components, has limited movable parts, openings, and/or non-bonded seams when assembled, and is constructed to be provided to the user in a non-fully assembled configuration.

### BACKGROUND OF THE INVENTION

Many environments employ the use of platform carts to effectuate convenient transport of parts, tools, supplies, and finished products through the manufacturing process and about the manufacturing environment. Many such carts include discrete movable features, such as removable trays and/or collapsible and/or extendable handle assemblies to provide discrete configurations of the platform carts to satisfy the user's requirements and/or desires associated with interaction with and use of such carts. While the adjustability of the configuration of such platform cart assemblies proves advantageous or desirous for many users, such features prove unsuitable for use in other environments.

Medical and electronic device manufacturers are but two of many industries whose needs or preferences have been less than satisfied by currently available platform cart assemblies. Such industries commonly operate one or more clean room environments associated with the manufacture of their underlying products. Ingress of particulates to the clean room environments can detrimentally affect the quality and/or operability of the underlying components and devices being manufactured and/or assembled in such clean room environments. Cart assemblies having moveable or adjustable structures or portions of the underlying assembly increase the potential for the inadvertent collection and/or transportation of particulates between manufacturing environments. Due to the attenuate risks, platform carts having adjustable constructions are less than desirable for clean room applications.

Although providing a platform cart having a fixed shape or non-adjustable configuration or construction could mitigate hesitation attenuate to use of platform carts in clean room environments, such an approach includes various shortcomings. For instance, collapsible or adjustable platform cart assemblies can be conveniently stored and shipped both during manufacture and when deployed in the consumer environment. Further still, such devices can commonly be provided to the consumer in a collapsed configuration such that deploying the same requires no consumer assembly of the underlying cart assembly aside from unpackaging and provides the user with the initial introduction as to the collapsible and/or adjustable operation of the underlying cart assembly.

Still further, some clean room environments can be particularly sensitive to the generation and/or transmission of electrical charges. To facilitate the robust construction of platform carts, whether adjustable or not, many carts employ constructions that include conductive elements such as steel tubes, connectors, or the like. Whereas such constructions facilitate a robust construction of the underlying cart assembly, such approaches increase the potential for unintended and/or undesired communication of electrical signals between the platform cart, materials and/or components associated therewith, and/or other conductive structures associated with clean room environments.

Accordingly, there is a need to provide a platform cart assembly that is constructed to accommodate rolling transport of the cart and goods associated therewith, has a robust construction that mitigates seams and/or gaps that may collect debris or pollutants adverse to clean room environment applications, has a predominantly non-conductive construction, and that is constructed in a manner that the platform cart to be provided in a compact form factor for storage and shipping with limited end consumer assembly to configure the platform cart into a fixed shape final form factor.

### SUMMARY OF THE INVENTION

The present invention provides numerous advantages over the prior art. The present invention provides a rolling platform cart assembly that is defined by a platform constructed to support goods and is constructed of primarily non-conductive elements that are preferably constructed of polyvinyl chloride material, is provided in a fixed shape construction when assembled, and is constructed in a manner that allows the platform cart assembly to be packaged and distributed in a compact form factor and requires limited assembly by the end consumer.

These and other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications. Other features, objects, aspects, and advantages of the invention are made apparent from the following description taken together with the drawings. It is further appreciated that the various features, aspects, objects, and advantages disclosed above are not mutually exclusive to the specific aspects of the invention such that the various discrete features, aspects, objects, and advantages are usable and/or combinable with one another.

### DESCRIPTION OF THE DRAWINGS

The drawings illustrate the best mode presently contemplated of carrying out the invention.

In the drawings:

FIG. 1 is a perspective view of a platform cart assembly according to the present invention and oriented in an in-use or deployed configuration;

FIG. 2 is a perspective view of an underside of the platform cart assembly shown in FIG. 1;

FIG. 3 is a cross-section elevation view of the platform cart assembly shown in FIG. 1 taken along line 3-3;

FIG. 4 is a view similar to FIG. 3 taken along line 4-4 shown in FIG. 1;

FIG. 5 is a perspective view of an underside of the platform cart assembly shown in FIG. 1 with the handle and gusset structures removed therefrom and a series of caster exploded therefrom; and

FIG. 6 is a perspective view of the platform cart assembly shown in FIG. 1 with the handle and gusset structures exploded therefrom.

Various aspects of the invention are described in detail with reference to the drawings, wherein like reference numerals, including the reference numeral designations, represent like parts and assemblies throughout the several views. Reference to one embodiment does not limit the scope of the claims attached hereto. Additionally, any examples set forth in this specification are not intended to be limiting and merely set forth some of the many possible embodiments for the appended detailed description and claims.

### DETAILED DESCRIPTION OF THE PREFERRED EMBODIMENT

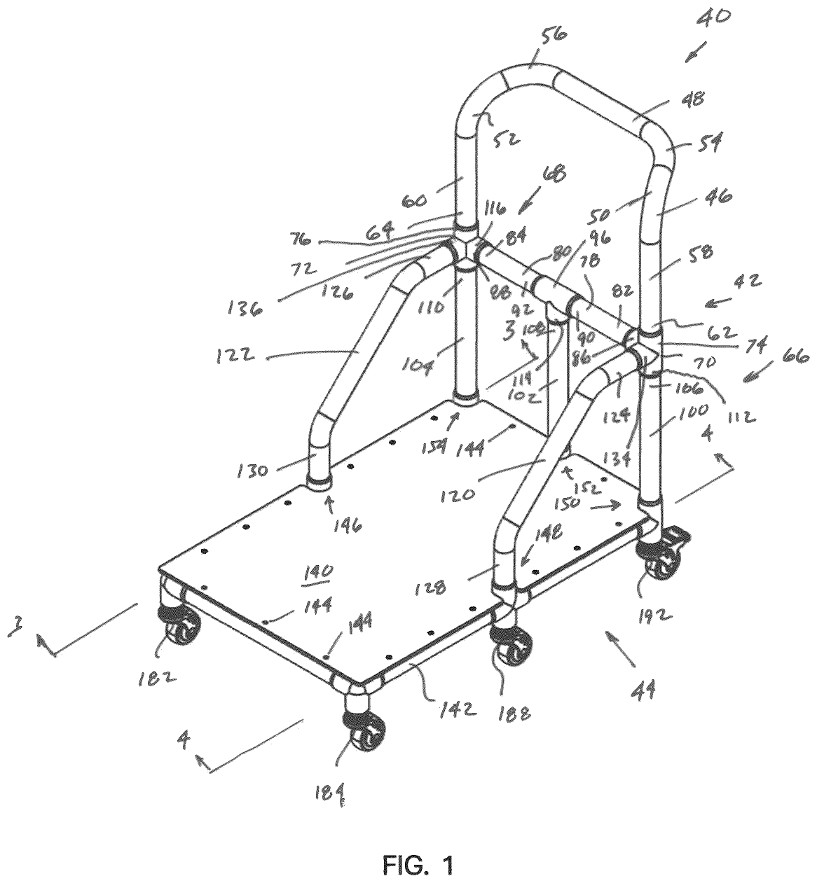

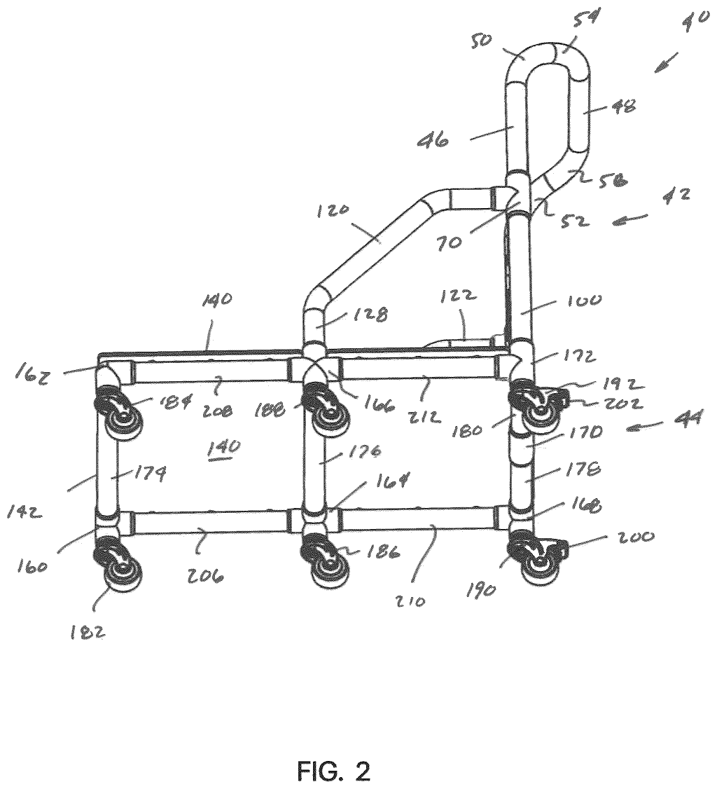

The present invention discloses a method of providing or forming and a platform cart assembly 40 having limited adjustable or movable structures, which is constructed primarily of interconnected polyvinyl chloride (PVC) elements or components, and is manufactured to require limited assembly by the end user but which can be distributed in a compact form factor to facilitate distribution and handling of the platform cart assemblies prior to being deployed in discrete environments. Referring to FIGS. 1 and 2, platform cart assembly 40 according to the present invention includes a handle assembly 42 that is constructed to be permanently affixed to, and extend upward from, a deck assembly 44. Handle assembly 42 includes a center portion 46 that defines a push/pull grip site or simply a handle 48 and is preferably preformed of a continuous section of PVC tube. Center portion 46 includes a pair of respective curved portions or sections 50, 54; and 52, 56; that are disposed at generally opposite outboard lateral ends of push handle 48. Respective drop tubes 58, 60 extend downwardly from the respective adjacent curved sections 50, 52 of center portion 46. The respective pairs of curved sections 50, 54 and 52, 56 of center portion 46 and drop tubes 58, 60 are oriented or contoured to position handle 48 generally rearward and above deck assembly 44. Center portion 46 terminates at a first end 62 and a respective second end 64 that are disposed proximate respective opposite lateral sides 66, 68 of cart assembly 40. Such considerations facilitate user interaction with push/pull handle 48 to facilitate translation of platform cart assembly 40 without deck assembly 44 interfering with the motion of the user's feet during rolling movement of platform cart assembly 40.

A respective fitting or elbow 70, 72 is permanently affixed to each of ends 62, 64 of center portion 46 of handle assembly 42. Each elbow 70, 72 is generally defined as a four-way elbow fitting and is preferably constructed of schedule 40 PVC material. In a preferred aspect, each elongate section and each fitting associated with defining each of handle assembly 42 and deck assembly 44 are constructed of 1 ¼ PVC tube and fittings that are constructed to be permanently bonded to one another. It is however appreciated that other dimensions, such as 1 ½ inch PVC tubing and fittings, and/or combinations thereof, with employment of suitably configured adapters, may be employed in the formation of handle assembly 42 and deck assembly 44 and the intended interaction therebetween.

Without deference to the specific material dimensions employed, end 62 of center portion 46 is permanently affixed to a first lobe 74 of elbow 70 whereas second end 64 of center portion 46 is permanently affixed to lobe 76 of elbow 72. Preferably, respective ends 62, 64 are glued into the corresponding lobes 74, 76 associated with respective elbows 70, 72. It is further appreciated that one or more of the various fittings and related elongated members associated with forming one or both of handle assembly 42 and deck assembly 44 could be provided in a configuration wherein the fittings are constructed to receive the discrete ends of the adjacent elongate members and/or wherein the discrete ends of the elongate members could be constructed to receive a respective lobe of a respective fitting into a respective open end of the respective elongate member. Said in another way, it is appreciated that either of the various elongate members and/or various fittings could be configured to define a discrete plug, pin, or prong intended to slidably cooperate with the respective receptacle, slot, or socket associated with an adjacent one of the other of the elongate members and/or fittings to provide the overlapping association with the adjacent structure to effectuate a permanent connection therebetween.

As shown, respective lateral tubes 78, 80 are defined by respective first ends 82, 84 that are constructed to be glued to a second lobe 86, 88 of elbows 70, 72 and respective second ends 90, 92 that are glued into another fitting in the form of a T-shaped fitting 96 such that lateral tubes 78, 80 are aligned with one another. A series of drop tubes 100, 102, 104 each define a first end 106, 108, 110 that are glued to a respective lobe 112, 114, 116 of elbows 70, 72 and T-fitting 96 such that drop tubes 100, 102, 104 extend in a generally downward direction therefrom and are coplanar with one another. Respective gusset or brace tubes 120, 122 are formed in a continuous manner and extend from a respective first end 124, 126 to a respective second end 128, 130. Respective first ends 124, 126 of respective brace tubes 120, 122 are constructed to be glued to respective lobes 134, 136 of elbows 70, 72 such that respective second ends 128, 130 of brace tubes 120, 122 are offset in a forward oriented direction relative to elbows 70, 72 and in parallel orientation relative to drop tubes 100, 104. Center portion 46; elbows 70, 72; T-fitting 96, lateral tubes 78, 80; drop tubes 100, 102, 104; and brace tubes 120, 122 defined handle assembly 42 of platform cart assembly 40 and, when assembled, are oriented such that the lower ends of drop tubes 100, 102, 104 and lower ends of brace tubes 120, 122 are orthogonal and coplanar relative to one another.

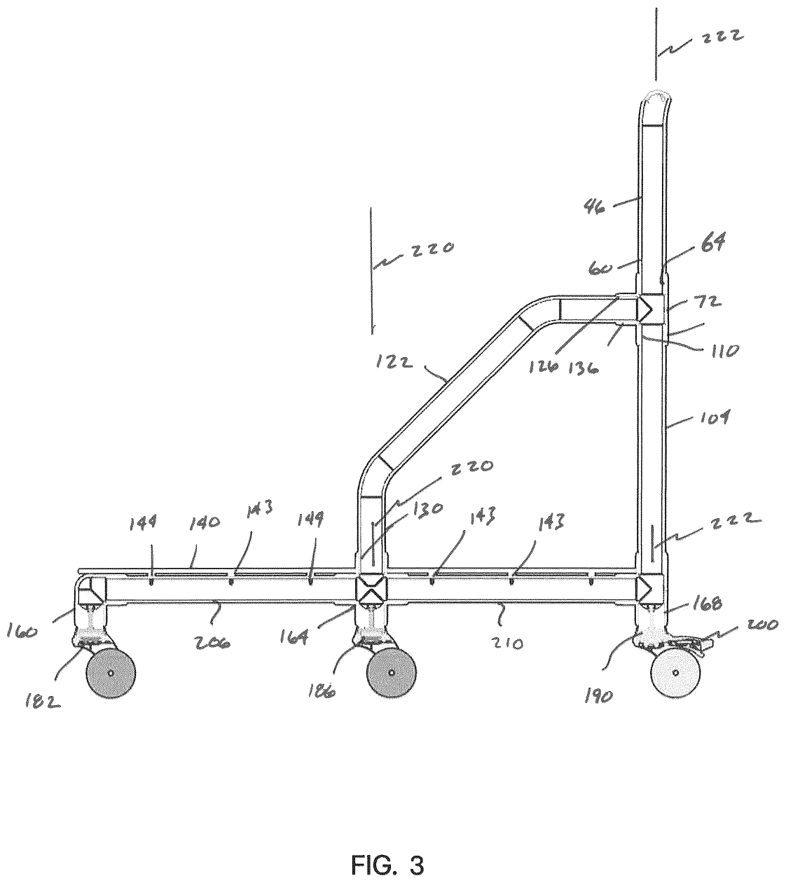

Deck assembly 44 includes a platform 140 that is constructed to be secured to a base frame 142. Platform 140 is preferably constructed of a plastic material such as PVC, resin, or preferably polypropylene materials to facilitate the rigidity, non-conductive, and readily cleanable nature thereof. A plurality of fasteners 144 pass through a perimeter of platform 140 and engage base frame 142 to secure platform 140 relative thereto. Preferably, one or more spacers 143 (FIG. 3) are disposed between platform 140 and base frame 142 associated with each of fasteners 144 so as to provide a relative planar orientation of platform 140 relative to base frame 142 and to accommodate a gap formed by the overlap of the elongate members and the fittings associated with defining base frame 142. Spacers 143 can be constructed of various materials such as stainless steel or the like or plastic or preferably nylon materials. Platform 140 includes a number of cutouts 146, 148, 150, 152, 154 that are shaped and oriented to accommodate respective lobes defined by base frame 142 such that the discrete lobes are left unobstructed for engagement with the respective ends of brace tubes 120, 122 and drop tubes 100, 102, 104 when handle assembly 40 is to be secured to base frame 142.

Base frame 142 includes a pair of forward elbows 160, 162; a pair of median elbows 164, 166; and a series of handle elbows 168, 170, 172. Respective lateral tubes 174, 176 extend between and are permanently affixed to respective ones of forward elbows 160, 162 or median elbows 164, 166. Lateral tubes 178, 180 are disposed generally below drop tubes 100, 102, 104 and extend between respective elbows 168, 172 and T-fitting 170 associated with center drop tube 102. A caster wheel assembly 182, 184, 186, 188, 190, 192 is engaged with each of elbows 160, 162, 164, 166, 168, 172 and facilitates rolling transport of platform cart assembly 40 during use thereof. One or more of caster wheel assemblies 182, 184, 186, 188, 190, 192 may include a selectively operable brake 200, 202 to facilitate selective limitation of rolling transport of platform cart assembly 40 when desired. Base frame 142 includes a plurality of longitudinal tubes 206, 208, 210, 212 that offset respective elbow pairs 162, 166; 172 160; 164, 168 relative to one another along the longitudinal length of platform cart assembly 40.

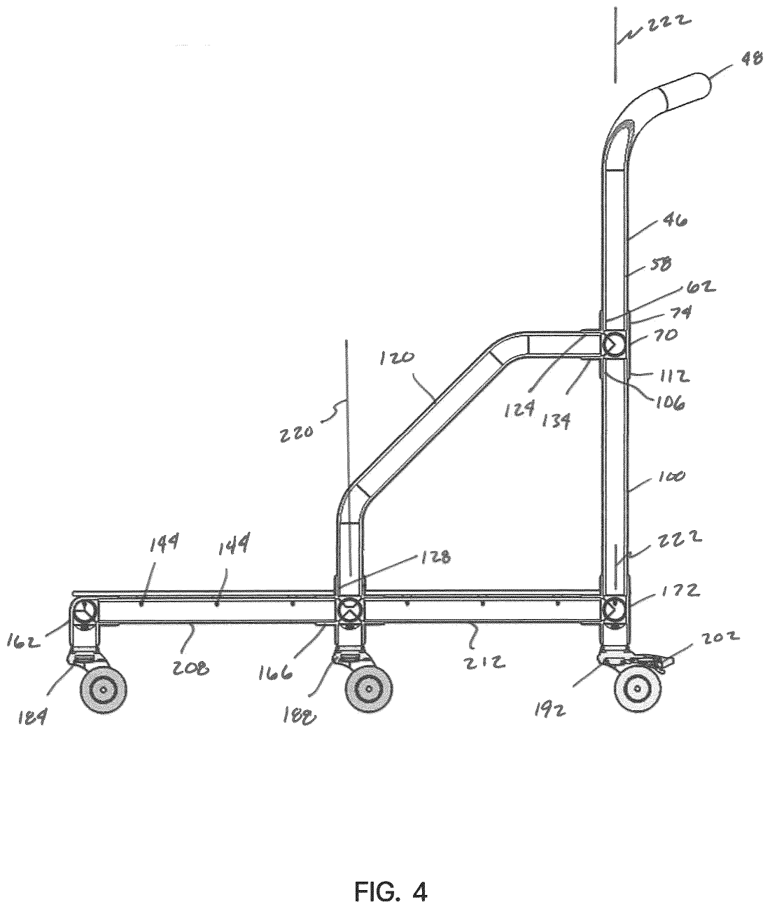

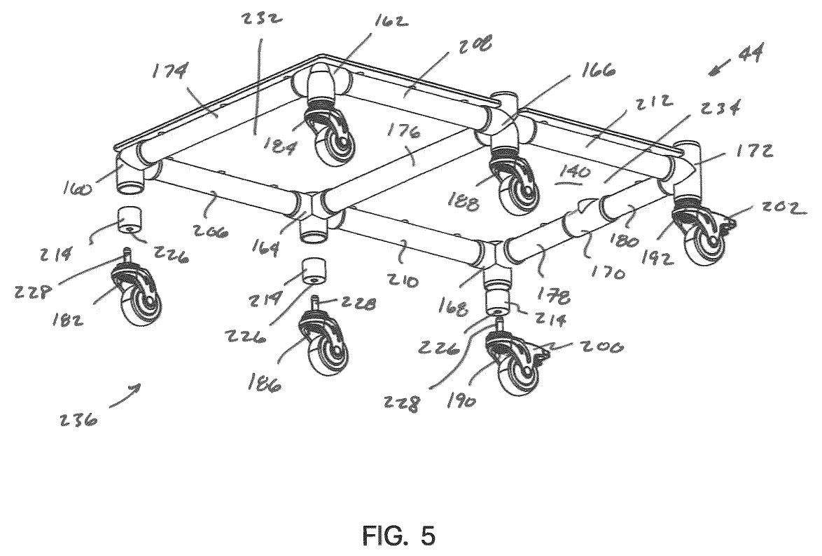

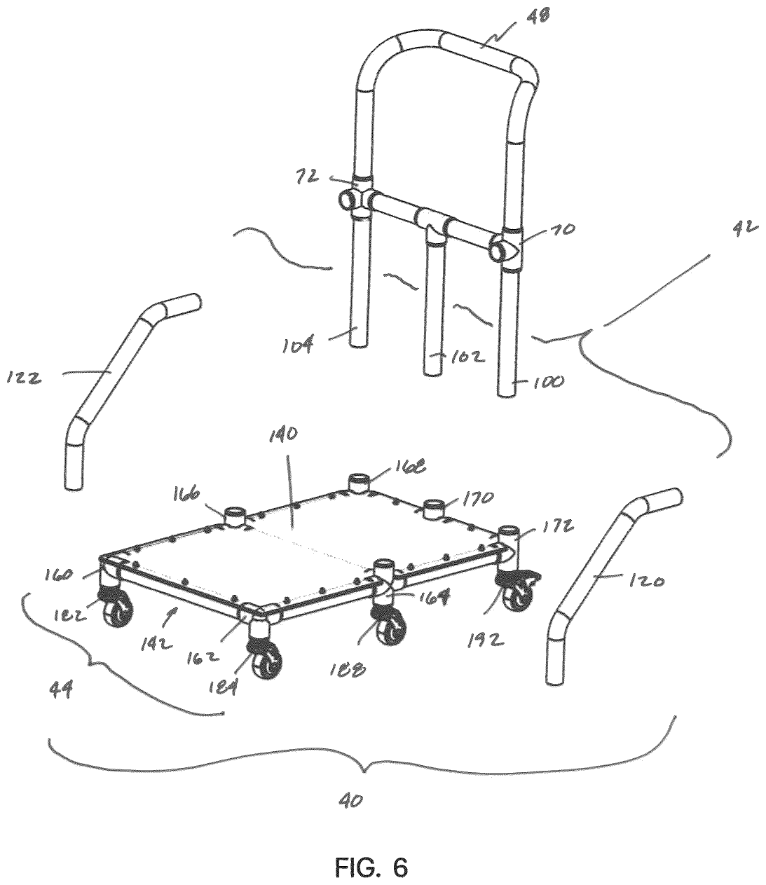

Referring to FIGS. 3 and 4, during assembly of platform cart assembly 40, handle assembly 42 and deck assembly 44 can be fully assembled prior to attaching handle assembly 42 to deck assembly 44. When handle assembly 42 and deck assembly 44 are individually assembled and prior to permanent connection thereof, lower ends of brace tubes 120, 122 and drop tubes 100, 102, 104 overlie respective fittings associated with base frame 142 such that handle assembly 42 can be permanently attached to deck assembly 44 via longitudinal translation of handle assembly 42 relative to deck assembly 44 along respective axis-indicated by lines 220, 222. As disclosed further below with respect to FIGS. 5 and 6, once handle assembly 42 is permanently affixed to deck assembly 44, brace tubes 120, 122 reinforce user interaction with handle assembly 42 relative to deck assembly 44 to accommodate movement of platform cart assembly 40 without translation of handle assembly 42 relative to deck assembly 44 such that, when fully assembled, cart assembly 40 is provided in a fixed or permanent form factor as shown in FIGS. 1 and 2.

Referring to FIG. 5, an insert or insert fitting 224 is constructed to be permanently secured to a downward facing lobe of each fitting 160, 162, 164, 166, 168, 172 of base frame 142. Each insert fitting 224 includes a bore 226 that is shaped to receive a stem 228 associated with each caster assembly 182, 184, 186, 188, 190, 192 such that each discrete caster assembly 182, 184, 186, 188, 190, 192 is rotatable relative to base frame 142 when secured thereto and such that platform cart assembly 40 is 360 degrees translatable when supported by a floor surface. As disclosed further below, respective open cavities 232, 234 are defined by a downward facing surface 236 of base frame 142. Cavities 232, 234 are bounded by an underside of platform 140 and the respective adjacent ones of lateral tubes 174, 176, 178, 180 and longitudinal tubes 206, 208, 208, 212 when base frame 142 of deck assembly 44 is assembled. Cavities 232, 234 are preferably constructed to receive caster assemblies 182, 184, 186, 188, 190, 192 prior to engagement of caster assemblies 182, 184, 186, 188, 190, 192 with base frame 142 by an end user.

Referring to FIG. 6, platform cart assembly 40 is constructed to be delivered to a consumer in a partially assembled configuration wherein the generally elongate structures associated with handle assembly 42 and deck assembly 44 have been previously formed and permanently affixed to one another via the plurality of fittings associated therewith. Such consideration allows casters 182, 184, 186, 188, 190, 192 and brace tubes 120, 122 to be disposed in and/or generally overlie cavities 232, 234 (FIG. 5) and handle assembly 42 to be disposed generally thereover such that handle 48 can be disposed to overlap a portion of deck assembly 44. Said in another way, platform cart assembly 40 is packaged and shipped to an end user in a slightly less than fully assembled configuration such that the generally elongate structures of handle assembly 42 and deck assembly 44 can overlie one another in a generally parallel orientation and such that brace tubes 120, 122 and casters 182, 184, 186, 190, 192 can be captured generally therebetween and/or there-along to reduce the volume defined by lines tangent to the perimeter edges of platform cart assembly 40 when assembled. Such considerations allow platform cart assembly 40 to be provided in a generally flat and/or more compact form factor for storage and transport of platform cart assemblies 40 during manufacture and shipping and prior to deployment thereof while requiring deminimus assembly thereof by end users.

Deck assembly 44 is provided with platform 140 secured to base frame 142 and various fittings 160, 162, 164, 166, 168, 170, 172; and inserts 214 (FIG. 5) previously assembled such that fittings 164, 166 and fittings 168, 170, 172 are oriented to cooperate with respective ends of brace tubes 120, 122 and drop tubes 100, 102, 104 of handle assembly 42 during user assembly thereof. Preferably, prior to engagement with deck assembly 44, brace tubes 120, 122 are glued to respective fittings 70, 72 defined by handle assembly 42 such that downward lateral translation of fully assembled handle assembly 42 relative to deck assembly 44 effectuates the permanent and secure connection of respective drop tubes 100, 102, 104 and respective lower ends of brace tubes 120, 122 of handle assembly 42 relative to discrete fittings 164, 166, 168, 170, 172 defined by deck assembly 44. Preferably prior to, but also accommodated after attachment of handle assembly 42 relative to deck assembly 44, respective caster assemblies 182, 184, 186, 188, 190, 192 can be engaged with respective inserts 214 associated with base frame 142 in a snap fit manner such that each of the discrete casters extends in a generally downward direction or direction opposite deck assembly 44 relative to handle assembly 42 and thereby providing a permanent and non-separable configuration of platform cart assembly 40 to accommodate use thereof as a platformed rollable goods and materials transport vehicle. When the various PVC tubes and PVC fittings are permanently connected to one another in the in-use configuration as shown in FIG. 1, the glued connections between the various frame elements provides a sealed interaction therebetween and mitigates the ingress of debris or other undesirable fluids between structures of the platform cart assembly and facilitates convenient cleaning and/or decontamination of the same without degrading the construction of cart assembly. The predominantly PVC material construction of platform cart assembly 40 further limits the conductivity of cart assembly 40 and the components thereof with ancillary structures associated with the environment of use and/or electronic devices and/or goods transported or supported thereby.

Therefore, one embodiment of the present invention includes a platform cart assembly having a deck assembly and a handle assembly connectable thereto. The deck assembly has a plurality of polyvinyl chloride (PVC) fittings that are permanently secured to one another by a plurality of PVC tube sections that offset each of the PVC fittings from one another and such that a group of the PVC fittings include a lobe that faces an upward direction. A platform is secured to the deck assembly such that the platform does not overlap any of the lobes of the group of PVC fittings that face in the upward direction. A plurality of inserts that each define a bore and are permanently secured to respective ones of the plurality of the PVC fittings of the deck assembly. A plurality of caster assemblies are constructed to be secured to the deck assembly via slideably engagement with the bore of a respective one of the inserts. The handle assembly has a plurality of PVC fittings that are permanently secured to one another by a plurality of PVC tube sections and is constructed to be permanently secured to the deck assembly by cooperation of respective ones of the plurality of PVC tube sections with respective lobes of the group of PVC fittings that face in the upward direction.

Another embodiment of the invention includes a kit for forming a platform cart assembly. The kit includes a deck assembly having a platform that is attached to a base frame formed of a plurality of polyvinyl chloride (PVC) fittings and PVC tubes that are permanently attached to one another and wherein a group of the PVC fittings define an upward directed lobe and a downward directed lobe. A handle assembly is defined by a plurality of PVC fittings and PVC tubes that are permanently connected to one another and wherein a group of the PVC tubes of the handle assembly are constructed to be permanently secured to respective ones of the group of PVC fittings of the deck assembly that define upward directed lobes. A pair of braces that are each constructed to be permanently secured to respective forward-facing lobes defined by the handle assembly and respective ones of the group of PVC fittings of the deck assembly that define upward directed lobes. The kit includes a plurality of casters that are constructed to be secured to respective PVC fittings of the deck assembly and wherein at least two of the plurality of casters are secured to respective PVC fittings of the deck assembly that also define upward directed lobes. The handle assembly and pair of braces are permanently secured to the deck assembly by an end user of the platform cart assembly defined by the kit.

A further embodiment of the present invention includes a method of forming a platform cart having a handle assembly that is formed by gluing a plurality of multiple lobed polyvinyl (PVC) fittings to a plurality of PVC tubes to form a handle frame. A deck assembly is formed by gluing a plurality of multiple lobed PVC fittings to a plurality of PVC tubes to define a base frame. A platform is formed with a plurality of cutouts and attached to the base frame such that the platform does not overlie upwardly directed lobes of the plurality of multiple lobed PVC fittings that define the base frame. A plurality of PVC brace tubes are provided that have a non-linear shape and are each constructed to be glued to a respective open lobe defined by the handle assembly and a respective open lobe of a respective one of the upward directed lobes of the PVC fittings of the handle frame. A plurality of inserts are provided that are constructed to be glued to respective ones of the plurality of multiple lobed PVC fittings of the deck assembly such that the plurality of inserts face in an opposite direction relative to the handle assembly when the handle assembly is secured to the deck assembly. A plurality of casters are provided that are each constructed to be attached to respective ones of the plurality of insert and the the platform cart assembly is deliverable to a user with the deck assembly unattached to the handle assembly and the PVC brace tubes.

These and other aspects, objects, features, embodiments, and advantages of the invention will become apparent to those skilled in the art from the following claims. It should be understood, however, that the detailed description and the specific examples provided therein, while indicating preferred embodiments of the present invention, are given by way of illustration and not of limitation. Many changes and modifications may be made within the scope of the present invention without departing from the spirit thereof, and the invention includes all such modifications. Other features, objects, aspects, and advantages of the invention made apparent from the above description taken together with the drawings. It is further appreciated that the various features, aspects, objects, and advantages disclosed above are not mutually exclusive to the specific aspects of the invention such that the various discrete features, aspects, objects, and advantages are usable and/or combinable with other another.

I claim:

1. A platform cart assembly comprising:
a deck assembly having a plurality of polyvinyl chloride (PVC) fittings that are permanently secured to one another by a plurality of PVC tube sections that offset each of the PVC fittings from one another and such that a group of the PVC fittings include a lobe that faces an upward direction;
a platform secured to the deck assembly that does not overlap any of the lobes of the group of PVC fittings that face in the upward direction;
a plurality of inserts wherein each insert is permanently secured to respective one of the plurality of the PVC fittings of the deck assembly and defining a bore;
a plurality of caster assemblies constructed to be secured to the deck assembly via slideably engagement with the bore of a respective one of the inserts; and
a handle assembly having a plurality of PVC fittings that are permanently secured to one another by a plurality of PVC tube sections and which is constructed to be permanently secured to the deck assembly by cooperation of respective ones of the plurality of PVC tube sections with respective lobes of the group of PVC fittings that face in the upward direction.

2. The platform cart assembly of claim 1 wherein the handle assembly further comprises a plurality of brace tubes that extend between a vertical portion of the handle assembly and are permanently secured to the deck assembly forward of a vertical plane defined by the handle assembly.

3. The platform cart assembly of claim 2 wherein the plurality of brace tubes are oriented on opposite lateral sides of the handle assembly and the deck assembly.

4. The platform cart assembly of claim 2 wherein respective ends of each of the plurality of brave tubes are permanently secured to the handle assembly and the deck assembly at orthogonal angles.

5. The platform cart assembly of claim 1 wherein the handle assembly further comprises a middle drop tube that extends between the handle assembly and the deck assembly.

6. The platform cart assembly of claim 1 wherein the handle assembly further comprises a bent handle tube that extends upward and rearward of engagement of the handle assembly with the deck assembly.

7. The platform cart assembly of claim 1 wherein at least one of the plurality of caster assemblies is lockable.

8. A kit for forming a platform cart assembly, the kit comprising:
a deck assembly having a platform attached to base frame formed of a plurality of polyvinyl chloride (PVC) fittings and PVC tubes that are permanently attached to one another and wherein a group of the PVC fittings define an upward directed lobe and a downward directed lobe;
a handle assembly defined by the plurality of PVC fittings and PVC tubes that are permanently connected to one another and wherein a group of the PVC tubes are constructed to be permanently secured to respective ones of the group of PVC fittings of the deck assembly that define upward directed lobes;
a pair of braces that are each constructed to be permanently secured to respective forward-facing lobes defined by the handle assembly and respective ones of the group of PVC fittings of the deck assembly that define upward directed lobes;
a plurality of casters constructed to be secured to respective PVC fittings of the deck assembly and wherein at least two of the plurality of casters are secured to respective PVC fittings of the deck assembly that also define upward directed lobes; and
wherein the handle assembly and pair of braces are permanently secured to the deck assembly by an end user.

9. The kit of claim 8 wherein the handle assembly and plurality of braces are aligned with the deck assembly prior to unpackaging.

10. The kit of claim 8 further comprising a PVC glue having a volume sufficient to glue the plurality of the braces to the handle assembly and the plurality of braces and the handle assembly to the deck assembly.

11. The kit of claim 8 further comprising a plurality of inserts that are permanently secured to respective ones of the downward facing lobes of the plurality of PVC fittings of the deck assembly.

12. The kit of claim 8 further comprising a platform secured to the deck assembly prior to packaging of the kit for distribution.

13. The kit of claim 8 further comprising a plurality of fasteners and spaces that secure the platform to the deck assembly.

14. A method of forming a platform cart, the method comprising:
forming a handle assembly by gluing a plurality of multiple lobed polyvinyl (PVC) fittings to a plurality of PVC tubes to form a handle frame;
forming a deck assembly by gluing a plurality of multiple lobed PVC fittings to a plurality of PVC tubes to define a base frame;
forming a platform with a plurality of cutouts and attaching a platform to the base frame such that the platform does not overlie upwardly directed lobes of the plurality of multiple lobed PVC fittings that define the base frame;
providing a plurality of PVC brace tubes that have a non-linear shape and are each constructed to be glued to a respective open lobe defined by the handle assembly and a respective open lobe of a respective one of the upward directed lobes of the PVC fittings of the handle frame;
providing a plurality of inserts that are constructed to be glued to respective ones of the plurality of multiple lobed PVC fittings of the deck assembly which that the plurality of inserts face in an opposite direction relative to the handle assembly when the handle assembly is secured to the deck assembly;
providing a plurality of casters that are each constructed to be attached to respective ones of the plurality of inserts; and
delivering the platform cart assembly to a user with the deck assembly unattached to the handle assembly and the PVC brace tubes.

15. The method of claim 14 wherein the platform cart assembly is delivered to an end user with the plurality of casters disengaged from respective ones of the plurality of inserts.

16. The method of claim 14 further comprising forming the plurality of PVC brace tubes such that each of the brace tubes and the handle assembly is secured to the deck assembly by axial translation of the deck assembly relative to the handle assembly and the brace tubes after the brace tubes have been permanently secured to the handle assembly.

17. The method of claim 14 further comprising packaging a supply of PVC glue with the platform cart assembly.

18. The method of claim 14 wherein each of the plurality of PVC fittings and the plurality of PVC tubes constructed to be permanently secured to one another such that the platform cart assembly has a permanent shape once assembled.

19. The method of claim 14 wherein at least one of the plurality of casters is lockable to prevent rotation of a wheel associated therewith.

20. The method of claim 14 wherein forming the deck assembly further comprises providing a caster connection associated with each fitting associated with a forward-facing end of the respective brace tubes.
